(19) United States
(12) Patent Application Publication
(10) Pub. No.: US 2002/0190831 A1
(43) Pub. Date: Dec. 19, 2002

(54) Sensor for measuring a direct current and a measuring method

(76) Inventors: Jurgen Hess, Vaterstetten (DE); Mauricio Esguerra, Taufkirchen (DE)

Correspondence Address: SCHIFF HARDIN & WAITE, 6600 SEARS TOWER, 233 S WACKER DR, CHICAGO, IL, 60606-6473, US

(21) Appl. No.: 10/169,242

(22) PCT Filed: Dec. 6, 2000
(86) PCT No.: PCT/DE00/04345

(30) Foreign Application Priority Data
Jan. 4, 2000 (DE) 100 00 116.5

(51) Int. Cl. H01F 38/20

(52) U.S. Cl. 336/174

(57) ABSTRACT

An inductive sensor on the basis of an annularly closed, soft-magnetic core (K) is disclosed wherein the current to be measured produces an inductive change within the annularly closed magnetic circuit, said inductive change being taken via a measurement winding (MW) wrapped around the core. In order to achieve a linear behavior within a broad range of measurement, the annularly closed core comprises core regions (KB) that comprise a magnetic composite powder material and, in particular, a ferrite polymer composite material (FPC).

For example, DE 31 30 277 A1 discloses sensors for measuring direct currents that employ slotted soft-magnetic cores, whereby a Hall sensor is arranged in the air slot. The current to be measured is thereby guided in a conductor that is placed around the soft-magnetic core as a winding or that is guided through the annular core, which is closed except for the air gap.

These sensors, however, can only be realized with a complicated and involved evaluation electronics since there is a non-linear dependency of the obtained measured values of the measured quantity to be identified. The measured result, moreover, is dependent on the gap size and on the Hall sensor employed, so that the known sensor must also be fabricated with high precision.

Other known current sensors are essentially composed of a soft-magnetic torroidal core through which a conductor with a current to be measured is conducted. A measurement winding (secondary winding) that is charged with alternating current is placed around the core. In a sensor disclosed by DE 36 13 991 A1, the electrical voltage at the measurement winding is measured, the time derivation thereof is formed, and the duration of the positive and negative half-wave of this derivation is utilized for evaluating the size and direction of the direct current to be measured. In a direct current sensor disclosed by German Published Application 2 300 802, the measurement winding is operated with a modulatable current source that generates a linearly rising or dropping pump current until a magnetic saturation of the core is achieved, this being identified in an additional measurement winding. The time average of the pump current is taken as a criterion for the current to be measured DE 22 28 867 B2 discloses a direct current sensor, whereby a square-wave half-wave current is supplied into the measurement winding, this to be regulated such that the periodic change in flux of the core remains constant. DE 38 27 758 C2 discloses a sensor for monitoring the intensity of the current of an alternating current.

An object of the present invention is to specify a sensor for measuring a direct current that supplies a measured value that exhibits an optimally linear dependency on the current intensity to be measured in an optimally broad range of current intensities, so that the measured value is proportional to the current to be measured within the entire range of measurement required.

This object is inventively achieved by a sensor having the features of claim 1. An inventive measuring method as well as advantageous development of the invention derive from the remaining claims.

The inventive sensor comprises a soft-magnetic core that, for example, is annularly closed or, respectively, fashioned such that a closed magnetic field can form within the core. At least one measurement winding is placed around the core that is connected to a device that is suitable for measuring the impedance and/or inductance at the measurement winding. The current conductor that carries the current to be measured is conducted through the opening of the closed core, so that the magnetic field can close around the conductor.

The magnetically closed core of (traditional) soft-magnetic material comprises a core region that has its cross-section formed of a magnetic powder composite material at least partially or over the entire cross-section. This inherently new material having soft-magnetic properties is composed of a matrix, particularly of a polymer matrix, in which traditional soft-magnetic particles of metal or metal oxide are embedded. Other materials and, in particular, in organic materials such as, for example, cement are also suitable for the matrix. The magnetic properties of the powder composite material are thereby defined by the soft-magnetic particles, particularly by their plurality or, respectively, density in the matrix, by their particle size and by the selection of material for the soft-magnetic particles. The matrix represents only the matrix that provides the necessary mechanical cohesion and is selected such that it remains stable in the range of the permitted operating conditions of the sensor and does not cause any negative influencing of the magnetic properties of the powder composite material.

A preferred powder composite material is ferrite polymer composite, also referred to in brief as FPC.

It is only with this core region composed of, for example, of FPC that the inventive sensor receives the required characteristic in order to be able to reliably determine the current intensity over a broad range of current intensities. This is possible given the inventive sensor as a result of a nearly linear dependency of the measured quantities of impedance (Z) or inductance (L) on the current intensity to be measured. If, in contrast, one were to employ a core for the sensor that is completely composed of traditional soft-magnetic material, then a corresponding sensor could only be utilized in a range of measurement that is limited relative to the invention.

A corresponding sensor with traditional soft-magnetic core without gap exhibits a non-linear behavior of the measured quantities Z or, respectively, L given low currents to be measured. A steep drop of the measured quantity is already observed given relatively low currents. A reliable allocation of the measured quantities to the current to be measured is only possible in a limited range of measurement.

A corresponding sensor with core of traditional soft-magnetic material with gap exhibits a constant behavior of the measured quantities at small currents and only exhibits a non-linear drop given high currents. Here, too, a reduced range of measurement is obtained.

The inventive current sensor having the core region composed of magnetic powder composite material and, in particular of FPC compensates these disadvantages in an advantageous way in that the characteristics of the FPC core region superimpose with the characteristic of the traditional soft-magnetic remainder of the core and a linear behavior of the measured quantities L and Z dependent on the superimposed DC current thereby derives over a broad range of measurement.

Another advantage of the inventive sensor is the possibility of adapting the sensor to different ranges of current measurement in a simple way in that simple parameters such as core shape, core size, material selection and FPC part are varied.

The largely linear dependency of the measured quantities on the direct current to be measured is also preserved given this adaptation.

The inventive sensor is simple to manufacture because of the clearly enhanced fabrication tolerance compared to the known current sensor composed of a slotted soft-magnetic core with a Hall sensor attached in the slot.

Devices for measuring impedance Z or inductance L are notoriously known and can be implemented with simple means. As a result of the nearly linear dependency of the measured values Z, L on the quantity I to be measured, a complicated evaluation electronics is also not required, so that a suitable evaluation circuit can be manufactured in an uncomplicated way and with little outlay.

When a basic DC current is superimposed on the direct current to be measured, the plurality of the current can be identified from the variation of the measured value.

The invention is explained in greater detail below no the basis of exemplary embodiments and the four Figures appertaining thereto.

FIG. 1 shows an inventive sensor having a torroidal core in a schematic illustration.

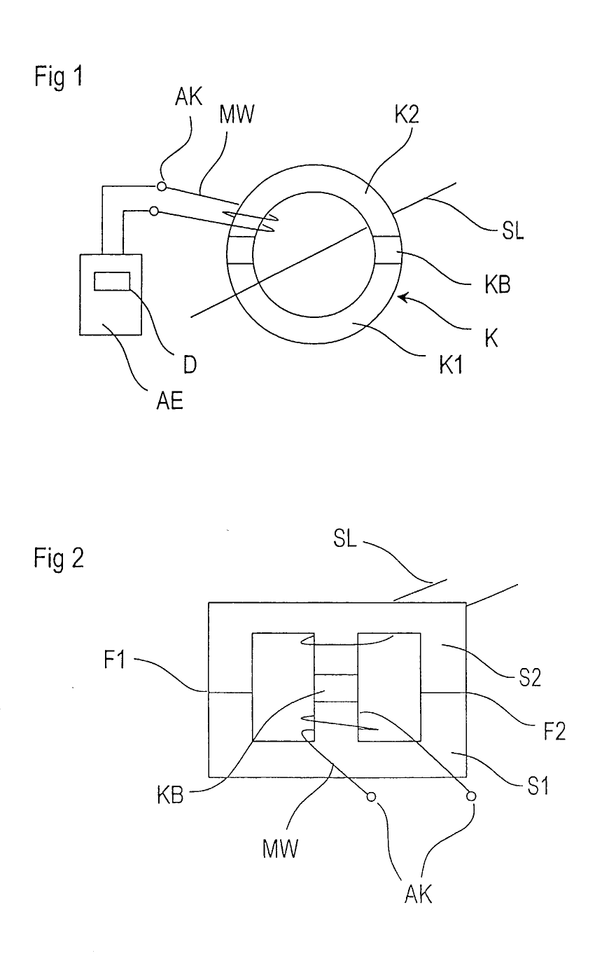

FIG. 2 shows a sensor having a E-core.

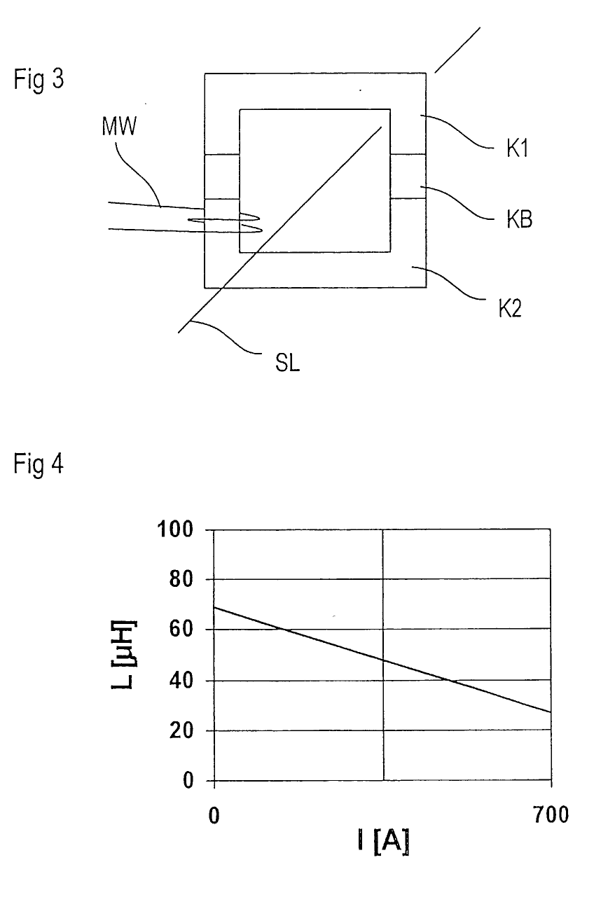

FIG. 3 shows a sensor having a U-core.

FIG. 4 shows a diagram indicating the dependency of the measured value L on the measured quantity I.

FIG. 1 shows the structure of an inventive sensor in a schematic illustration.

The soft-magnetic core K is annularly closed and comprises at least one core region KB that is formed of FPC. In the Figure, two core regions KB composed of FPC are shown. This has the advantage of a simple fabrication, since the two partial cores K1 and K2 that, for example, are identical can thus be brought into a corresponding position relative to one another and the gap between the “ends” of the two partial cores K1 and K2 can be subsequently filled up with FPC. The current conductor SL through which the current I to be measured is conducted proceeds through the annular core K. A measurement winding MW placed around the core K serves the purpose of determining the measured values Z or, respectively, L. These are identified in an evaluation AE that is connected to the measurement winding MW via the terminal contacts AK. The evaluation unit AE contains a known circuit for determining the measured values of impedance Z or inductance L that are taken at the terminal contacts AK of the measurement winding MW. These measured values can, for example, be supplied to a computer or, optionally, can be presented via a display D.

The current intensity I, which represents the measured quantity to be identified, can also be reproduced on the display D.

The geometry of the core K, which is indicated as being circular here in simplified fashion, can be arbitrarily varied. The cross-section of the core is likewise arbitrary, this, for example, being round, oval, rectangular or polygonal or also potentially assuming arbitrary shapes.

The share of the core region KB comprising FPC in the overall core K is also variable. In one embodiment of the invention, the entire core K is composed of FPC.

Compositions of suitable FPC materials may be found, for example, in Siemens Matsushita Components Datenbuch, “Ferrites and Accessories”, 1999, page 42. Suitable FPCs are identified therein as C 302, C350 and C 351. The FPC composition C 351 is particularly suited for sensor applications in the range up to 200° Celsius since the FPC material has a corresponding temperature resistance.

The geometry of the core region KB comprising the FPC can be arbitrarily varied. In one embodiment, the core region KB is solid, is completely composed of FPC and has the same cross-section as the rest of the core K. However, it is also possible to modify the cross-section of the core region compared to the cross-section of the remaining core and, for example, to leave a hollow. This is produced in a simple way by employing a FPC foil. Such a FPC foil is constructed of a polymer that is adequately flexible at the desired operating conditions, so that the foil can be arbitrarily shaped, folded and, in particular, wound. The material of the remaining core K is a traditional soft-magnetic material, particularly ferrite. The selection of the material ensues via the permeability and via the desired temperature behavior. The range of measurement to be covered can be set in a certain way via the permeability, whereby a high permeability leads to saturation being achieved at low currents, so that a core material with higher permeability is suitable for measuring lower currents then is a material having lower permeability given parameters that are otherwise unchanged.

A further possibility for setting the range of measurement of the inventive sensor is composed in the variation of the plurality of turns of the measuring winding. Also, the part of the core region KB comprising the FPC or the gap size filled with FPC given parameters that are otherwise unchanged. [sic] Another quantity to be taken into consideration is the frequency of the measurement current applied to the measurement winding MW. A suitable measuring frequency, for example, lies in the range from 1 through 100 MHz.

A further variation of the inventive sensor is comprised in the plurality and position of the core regions KB comprising FPC. In further embodiments of the invention, the plurality of these core regions can be arbitrarily increased.

The position of the measurement winding on the core K can also be varied corresponding to the plurality and size of the core regions KB comprising FPC.

FIG. 2 shows a further inventive sensor on the basis of a double E core. The Figure shows a core region KB comprising FPC in the region of the middle leg (middle bleb [sic]). The measurement winding MW also wraps the middle bleb, preferably in the region of the core region KB comprising FPC. The current conductor SL is likewise conducted around the middle bled, preferably as a one-turn winding. The two halves of the double E-core abut one another without air gap at the two remaining seams F1 and F2 of the double E-core. However, it is also possible to provide further core regions FPC in the region of these two joins F1 and F2.

Given the double E-core, too, there is the possibility of arbitrary variations with respect to the core material, the FPC, the core cross-section, the size and the proportion of the core region relative to the rest of the core.

Another embodiment of the inventive sensor is shown in FIG. 3. Here, a double, respectively U-shaped core is employed that preferably comprises core regions comprising FPC at both joins at which the two U-shaped core halves meet one another. For the rest, this embodiment is a modification of the core form shown in FIG. 1.

In FIG. 4, the measured values (L here) are entered relative to the measured quantity I to be identified for an embodiment of an inventive sensor, said measured quantity I being initially defined with a traditional current measuring device for calibration purposes. The allocation of the measured values L to the measured quantity I yields practically a straight line that corresponds to a nearly linear dependency of the measured value L on the measured quantity I. As a result of the high linearity, the measured quantity I to be identified can also be allocated simply, exactly and unambiguously and, thus, defined. The measured values themselves are obtained with a sensor that comprises a double U-shaped core according to FIG. 3. Given an overall leg length of approximately 40 mm, the core region composed of FPC comprises approximately 14 mm. As can be seen from-FIG. 4, a range of measurement between approximately 0 and 1000 amperes can thus be covered. On the basis of a corresponding adaptation of the variable parameters, this range of measurement can be arbitrarily expanded or, respectively, shifted upward or downward.

1. Sensor for measuring a direct current,
comprising a soft-magnetic core (K) of a given crossection in which an annularly closed magnetic field can form,
whereby the core comprises a core region (KB) that encompasses a magnetic composite powder material;
comprising a measurement winding (MW) around the core (K);
comprising a current conductor (SL) that is guided through the core and carries the current to be measured;
comprising a device that determines the impedance or the inductance of the core as measured value by means of a measurement circuit (AE) connected to the measurement winding (MW) and allocates said measured value to the intensity of the current of the direct current according to a linear dependency that is established given the core.

2. Sensor according to claim 1, whereby the magnetic composite powder material is a ferrite polymer composite—FPC.

3. Sensor according to claim 1 or 2, whereby the shape of the core (K) is selected such that the core can form a closed magnetic circuit.

4. Sensor according to one of the claims 1-3, whereby the core (K) is composed of ferrite except for said core region (KB).

5. Sensor according to one of the claims 1 through 4 that comprises two or more core regions (KB) in the core (K) that are partly or completely filled with FPC over the entire crossection.

6. Sensor according to claim 5, whereby the core (K) is fashioned hingeable in bipartite fashion, whereby the two parting locations (F) respectively lie in one of said core regions (KB) comprising FPC.

7. Sensor according to one of the claims 1 through 6, whereby the entire core (K) is composed of FPC.

8. Method for measuring a direct current in a current conductor (SL) that is guided through an annularly closed, soft-magnetic core (K) that comprises a core region (KB) composed of FPC, whereby the impedance or inductance of the core is determined as measured value via a measurement winding (MW) placed around the core and by means of a measurement circuit (AE) connected thereto and is allocated to the intensity of the current of the direct current.

9. Method according to claim 8, whereby the part of the core region (KB) composed of FPC is increased and/or the permeability of the core material is lowere for measuring a higher current intensity.

10. Method according to claim 8 or 9, whereby the current to be measured has a base DC current superimposed on it, and the polarity of the current is determined from the change of the measured value.

11. Method according to one of the claims 8 through 10, whereby the dimensioning of the core (K), the selection of material for core and FPC or the relative part of the core region (KB) composed of FPC are selected such that the current to be measured lies in the region of a linear dependency of the measured value on the current intensity.
